(19) United States
(12) Patent Application Publication
(10) Pub. No.: US 2015/0170535 A1
(43) Pub. Date: Jun. 18, 2015

(54) STUDENT-DRIVEN SYSTEM TO FACILITATE POST-SECONDARY CAMPUS STUDY AMONG MULTIPLE USERS BASED ON A COMMON EDUCATIONAL FOCUS

(71) Applicants: Solomon Negash, Kennesaw, GA (US); Mark R. Anderson, Kennesaw, GA (US)

(72) Inventors: Solomon Negash, Kennesaw, GA (US); Mark R. Anderson, Kennesaw, GA (US)

(21) Appl. No.: 14/572,155

(22) Filed: Dec. 16, 2014

Related U.S. Application Data
(60) Provisional application No. 61/917,184, filed on Dec. 17, 2013.

(51) Int. Cl. G09B 5/10

(52) U.S. Cl. CPC G09B 5/10

(57) ABSTRACT

A system and method for connecting multiple users to one another based on a specific course is disclosed. The specific course is associated with a classroom-based course. A web server and an electronic device in communication with the web server are provided. The electronic device is configured to permit authentication of a user identifier representing a user based on the user identifier's association with a common education focus such as a specific course. The user represents a student enrolled in the classroom-based course. The electronic device is configured to allow the user identifier to establish or join a session associated with the specific course. The session includes at least one other user identifier representing another student enrolled in the specific course.

This application claims priority to co-pending U.S. Provisional Application Ser. No. 61/917,184 filed Dec. 17, 2013 which is expressly incorporated by reference herein in its entirety.

A system and method for scheduling and inviting select users sharing a common educational course of study to virtual or physical meetings, which may also be referred to as sessions. In one embodiment, the users share the common feature of participating in a specific post-secondary course. In one embodiment, the educational environment includes a large student commuter population or the course is on-line, each of which typically makes scheduling and participating in collaborative meetings difficult. The user may be a full-time student, part-time student, enrolled student, audit student, and in embodiments the user may include faculty, adjunct faculty, teaching assistant, etc. The common feature is participation in a specific course, specific curriculum, specific major, etc. The contact list is determined by the enrollment of a specific course, and changes for each course. Unless two students have identical schedules, the contact list for each student will differ. Thus, unnecessarily notifications are eliminated.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates the general system business architecture.

FIG. 2 illustrates the component diagram from a technical architect perspective.

FIG. 3 shows a sample mobile application home page.

FIG. 4 shows a drop down home page menu item.

FIG. 5 shows a create option next to a join option.

FIG. 6 shows a sample repository of the sessions a student attended.

FIG. 7 shows a notifications option.

FIG. 8 shows a feedback menu.

The term university as used herein is used for convenience to encompass any physical or virtual educational post-secondary institute including a university, college, technical school, community college, vocational school, etc. The course may cover any subject. In one embodiment, the course is a science, mathematics, or engineering course that is typically challenging to students and requiring problem solving, laboratory components, modeling simulations, and/or exercises that would be facilitated by group dynamics and collective approaches.

The disclosed system and method encompasses computer supported collaboration and networking. In one embodiment participants collaborate using mobile devices exclusively. In one embodiment participants collaborate using mobile devices and desktop computing.

The disclosed system and method extends the classroom face-to-face student-to-student and student-to-professor collaboration beyond the physical classroom. Students use its networking platform to arrange physical meeting time and location, and to avail scheduled study sessions. Online features including voice, video, and text are added for students unable to participate in physical meetings. In one embodiment, the disclosed system and method provides a secured login interface, and authenticates only members that have registered for a specific course. It allows students to link with their classmates, to access location feature of their mobile device to identify location sessions, to archive lessons learned, to create a searchable knowledge repository, and to optionally provide professor and student feedback. By extending the physical meeting experience beyond the classroom, the disclosed system and method improves retention, progression, and graduation rates.

In one embodiment, the substantive meeting is scheduled at will, periodically, on an as-needed basis, etc. to cover various aspects of the educational experience, e.g., to facilitate student review of previously presented material, to provide supplementary resources and/or experiences to broaden and/or deepen knowledge of previously presented material, to focus on a specific problematic aspect of previously presented material, to facilitate student-faculty learning by collective or small-group interaction, etc.

One embodiment of the disclosed system includes a web server, i.e., a software application that provides internet-accessed web content, and an electronic device in communication with the web server being configured perform at least the following functions: to authenticate the user based on the user's university affiliation; to permit the authenticated user to establish a session or meeting; to permit the authenticated user to join a preexisting session or meeting; to provide notes, comments, etc. about the session or meeting after it has occurred. The session or meeting includes at least one additional user identifier representing an additional user that is affiliated with the specific course. In one embodiment, the web server is also in communication with a database server that stores information about the specific course and from which the user selects desired invitees, e.g., all other students, students with availability at certain time periods, students that commute versus students residing on-campus, students with a specific major in the course, etc. The database server stores a plurality of such user identifiers associated with the course.

Registration, profile update, dashboard home with map display, sessions, request session, invite session, member, and class are described below. In embodiments, the disclosed system and method has the following components.

Notifications may be by push or pull approaches and the user may choose between them to receive notifications of a session. In pull notification, the user initiates access to a session, e.g., clicking to join a session from a home page. In pull notification, the user chooses the types of sessions for which s/he seeks notification. The system then automatically notify the user when the session notification criteria are met. The disclosed system and method permits a user to alternate between pull and push notification at will.

In one embodiment, naming approaches allow the user a choice between two names with which to be known in the disclosed system and method. These two names are a university assigned network name (NetID), or a student-created pseudo name as an alias. In one embodiment, users must opt-out from using the pseudo name, when students opt-out of the pseudo name then the university assigned network name (NetID) is used. Students that set pseudo names will be identified using their user defined pseudo name instead of their NetID names.

In one embodiment, the user may create a new session from multiple interfaces. For example, the user may use a sessions page, a member page, or a class page. In each case a new session page opens upon user activation, e.g., when the user clicks a “create a new session” button. Inputs to the “create new session” page are course name and number, building name and number as meeting location, and notification format of either pull or push, as previously described. A session created with pull notification, the default, displays only in the location map of the home page for users to access, i.e., for the user to pull. A session created with push notification will be automatically sent as a notification to users who set their profile for push notification in addition to being displayed in the location map of the home page. A session creator can further indicate descriptive information about the course section being scheduled (e.g. chapter five of Math 1190 on trigonometry) and location (e.g. library northwest corner second floor). The session creator can choose among, e.g., invitations to participants as add/decline, select members, or auto.

In one embodiment, add/decline is a default setup. Once the session is created, users can request to join the session. Requests to join the session come to the session creator; s/he may accept the request hence adding the user to the session, or may decline the request hence declining adding the user to the session.

The session creator can activate a select member function, e.g., by clicking a button, at the time of creating the session. Activation opens a page listing members. In the member list page, the session creator indicates, e.g., checks a box next to a member name, selection of one or more specific members to invite to the session.

The auto function allows, at the time of session creation, the creator to specify the maximum number of participants for the session. With auto activated, e.g., checked, the system will accept, on a first-come-first-serve basis, users in the session and will automatically close the session when the pre-determined maximum number of participants is reached.

The search allows the user to search one or more sessions. The user may search by course name, number, and/or location. A summary of sessions stored in a knowledge repository can be searched using a keyword search (e.g., organic chemistry IUPAC naming, etc.)

Ratings allows users to rate each session, or rate a number of sessions; on coordination, value, knowledge conveyed, overall satisfaction, etc. Ratings may be performed using a five point Liked scale ranging from strongly agree to strongly disagree, or by other means (e.g., very useful, moderately useful, not useful). Session ratings are stored with the session creator profile. Participants may view prior session collective ratings in advance of joining a new session.

In one embodiment, registration must be performed in advance of use. Upon a user's first login, the user is directed to a central authentication service login page where the user is prompted to provide a NetID and associated password to obtain authentication and initiate registration. Registration requires the user to enter his/her name, university given identification number and network name, email address, and pseudo name, and requires the user to select between notification receipt by pull or push. The login information at registration is sent to the university security and authentication interface for validation. The university authentication interface authenticates valid university registered students and returns the authenticated network name back to the disclosed system and method. Non-authenticated users are directed to contact the university. Upon successful authentication, the user is redirected to the disclosed system and method. Users already registered are immediately redirected to the home page. Login/logout allows users to integrate with a university's central authentication serve. Integration with a central authentication service enables a single login so users need not re-enter their NetID and password with each access to different services on the system.

In one embodiment, users may change information entered during registration through the profile page including email use, pull vs. push notification, and pseudo name. Emails entered during registration are used to notify students about sessions and other activities. The profiles page permits students to perform a myriad of tasks. These include, e.g., enable/disable email, alter notifications, update pseudo name, update list of courses, etc.

In one embodiment, the disclosed system and method includes a home page, a session page, a requests page, an invites page, and a members page. Each is these is subsequently described.

The home page displays a location map of the university and its vicinity with unexpired study sessions noted with a color-coded bubble: e.g., red bubbles for sessions starting within 24 hours, blue bubbles for sessions that start outside the 24 hour period. Bubbles are displayed at map coordinates of the selected meeting location. When multiple sessions are scheduled at the same location, a different color bubble (e.g., orange) with the aggregated number of session counts inside the bubble is displayed. Clicking this bubble expands to list the sessions and provides information and allows joining the session.

The sessions page displays a summary of user sessions including sessions created, sessions joined, sessions of which the logged-in user is a member, and sessions requested. The sessions page also allows creation of a new session, e.g., button.

The requests page displays members request to join the session created by the logged-in user. The session creator adds or declines a member request to join the session. Added members will see the session in their session page as “member of”. Declined members will see their request without acceptance.

The invites page shows the invitation the user has received. When session creators choose the “select member” option and identify specific members desired for a session, the invites page of the desired members displays the invitation. Invited members must accept the invitation to participate in the session.

The members page displays a list of members, either by pseudo names if that was selected by the user as the desired setup name, or the university assigned NetID. Members with enabled email addresses can receive email notification on the members page.

The class page displays an approved list of university classes obtained from the registrar. The highest level of abstraction is by the course name abbreviation for the department, e.g., BIOL, CHEM, MATH, PHYS, etc. The next level of abstraction is with course level: 1000, 2000, 3000, 4000, etc. These levels can be expanded or collapsed. Course level numbers, e.g., MATH 1190, will display when the 1000 level in the MATH section is expanded. Each course designation will have a button to create a new session or a button to join the session, if an open session is already created for this course.

The disclosed system and method is executed using the following exemplary non-limiting embodiments. One skilled in the art appreciates these illustrate specific uses of the system, but that these uses may be supplemented, deleted, added, as student use is facilitated.

One embodiment is a mechanism by which course assignments are uploaded by session members, all students enrolled in the course, for selected groups (e.g., students seeking additional practice, students seeking remediation, students seeking advancement, etc.).

One embodiment is an access profile for instructors and other authorized facilitators to view student submissions if the student individually, or session members collectively, authorize such access. As one example, a student-authorized instructor login may be required, and may be activated for only a selected group of students, selected assignments, etc. at the user's discretion, maintaining the disclose system and method as student controlled. If desired, the student may permit instructor feedback, e.g., binding grades, non-binding grades, motivational commentary, suggestions, etc.

One embodiment is a user guide that provides documentation for a myriad of available services, e.g., web services, or detailed instructions for using the disclosed system and method.

One embodiment is a student portal that may sort sessions based on student registration.

One embodiment is a tracking system for sessions, number of students participating, names of students participating, time participating, etc.

One embodiment is an integration system allowing class tools and applications to extend the utility, content, applicability, etc. of a particular session. As one example, a student may learn how chemistry is integrated with culinary arts, food science, household products, veterinary applications, etc. prompting further study, providing career options, etc. As one example, a student may use a MyMathLab and a learning management system such as D2L to explore math applications in fields such as web design, graphic arts, etc.

One embodiment is a simulation system that allows users access to different programs that simulate concepts under study.

One embodiment is a virtual attendance mechanism permitting student participation in the absence of physical presence at a meeting location. This may be accomplished by, e.g., having the sessions available as a webinar type format, having webcam participation, etc.

One embodiment is a social networking link to tools such as Facebook, Twitter, RSS, YouTube, Linked In to facilitate collaboration.

In use, a student publishes a desire to study a particular course at specific location and time. This creates a study session. Members may choose a favorite study partner or buddy (representing a study session considered as valuable by its participants and persisted as a study session or buddy), set a location, and set a recurring schedule. A system alert is created and member students are notified based on the recurring schedule. A student searches through published study sessions and requests to join the session. A student can view basic profiles of member students. The organizer of a study session may accept or reject a request to join a session. For this purpose, the organizer may review the requesting student's profile. Participating session members may propose to change the subject or course scheduled for the study session. A study session may be closed if its member decline to invite new members. A study session may be parsed into multiple sessions with the same or different subjects. A study session may be set to automatically generate study sessions according to a pre-set recurring schedule. Users may be associated with more than one subject and/or course.

The disclosed system and method may include a research component. One embodiment is a field research component in the user's course of study. One embodiment is a research assessment of the value of the technology to the participants, e.g., a technology value assessment survey administered during the last week of class (e.g., https://www.surveymonkey.com/s/KimiteiSU2013).

In one embodiment, a pilot research class is conducted with a 20 minute in class group session with three students per group. The instructor indicates the assignment for the day, and group members collaborate during the session to solve a specific problem. At the end of the session one person from the group presents the group's solution. For such a pilot application, the participants are identified and the assignment is uploaded, with a specific due date, on the disclosed system and method. One person from the group sets up a study session with specific time and location; the session creator invites the group members. Group members meet at the specified time and location; download the assignment for the day; collaborate to solve the problem; and the session creator then summarizes the group work and submits the work to the system repository. The instructor reviews the submissions and may grade it, comment on it to the participants, comment on it to the class, request the students present it in class, etc.

The disclosed system and method is designed with scalable and flexible architecture. A web-based HTML5 development platform has a cross platform design with a single team and one application development code that is easy and cost effective to develop, deploy, and maintain. In one embodiment, the disclosed system is housed on a development server, limiting access to university presence. In one embodiment, the disclosed system is housed to a production server, permitting student use from non-university venues. Newer browsers continually provide more native capabilities. A university need not implement a separate development team and code, need not maintain multiple teams and multiple codes that are expensive to develop, deploy, and maintain. New device features can be added. Communications and commands may be executed through a mobile device. In one embodiment, every smart device has a generic application that would allow it to communicate with any other device and specify a web application that would allow the other device to consume its functions; this is supported by the HTML5 development platform approach.

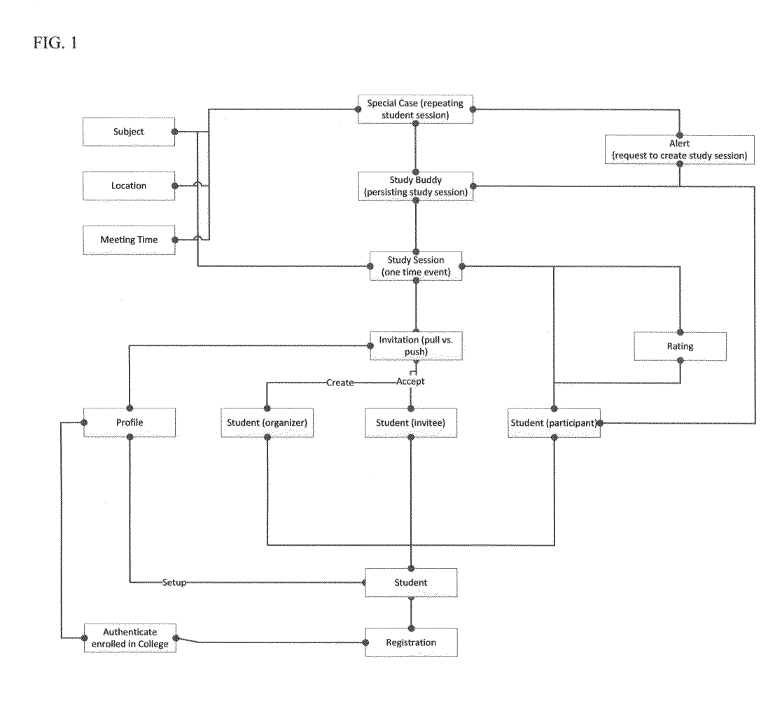

The system is generally illustrated in FIG. 1 which illustrates the business architecture. FIG. 1 shows a business analyst perspective of the interaction among system components. The registration component (bottom center) is the entry point.

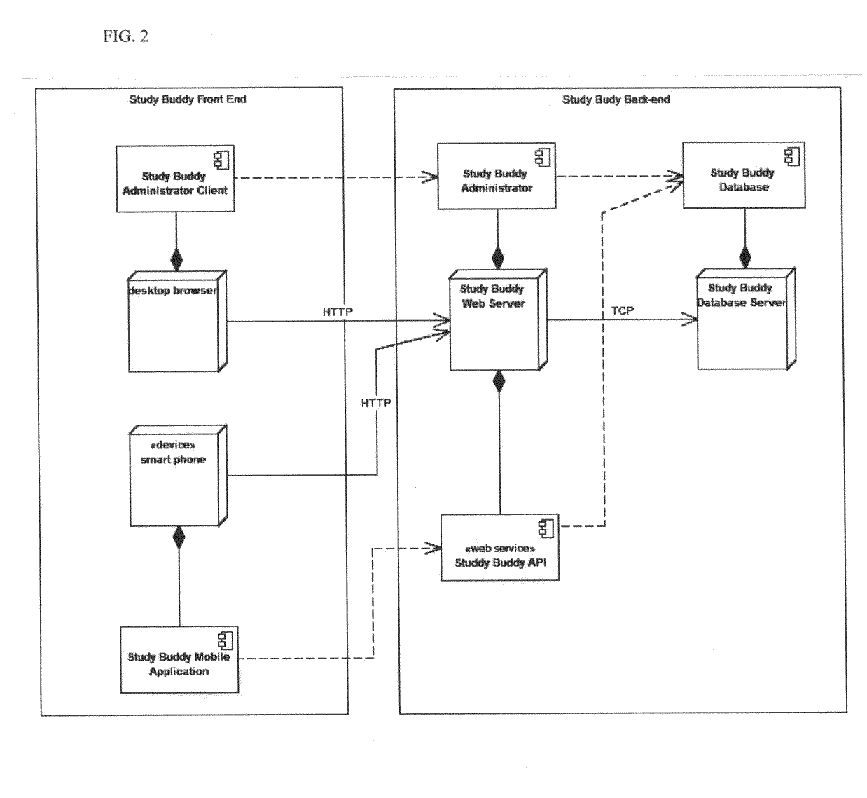

The disclosed system and method has the following technical architecture components, shown schematically in FIG. 2.

FIG. 2 illustrates the component diagram from a technical architect perspective. FIG. 2 shows two parts of the system: frontend and backend. The frontend is the user interface visible to the end user. The backend is a business logic layer and a database layer. The business logic layer handles the rules of the business. The database layer works with the database. Dotted lines show dependences between components. Solid lines show interactions between components. The interaction protocols are stated as HTTP and TCP.

A back end component is the behind the scene operation of the system. A front end is the mobile application or user interface. An administrative component performs administrative functions.

The back end maintain student profiles, allows session creation by any of ad hoc, participant based, or by breakdown of an existing session, request and approves membership to a session, promotes a session to a study session association, broadcasts alerts to members of a study session association when a study session is created.

The mobile application searches and identifies study sessions by subject, members, location, and/or keywords, requests membership to a study session, displays a map-based location of a study session, creates a study session, proposes change to the subject of a study session, proposes and implements parsing or breakdown of a study session, creates, manages, and/or joins a student study session, manages student membership, and merges study sessions.

The disclosed system and method is implemented using a variety of devices and software components. For example, the system may be implemented as a server application, accessible by a web browser. Alternatively, the system may be accessible through web enabled mobile devices (e.g., Apple iPhone® or iPad®). In another embodiment, portions of the system are implemented as a software application that may be downloaded to a mobile device such as a smart phone (e.g., iPhone®, BlackBerry®, Droid®), an iPod® touch or a tablet computer (e.g., iPad®). In embodiments, portions of the system are implemented as a software application that can be installed on desk top or laptop computers, a personal computing device, e.g., a PC. The portable electronic device may include control logic for downloading and installing an application from the web server that authenticates the user identifier for entry to the system, i.e., to initiate a session or meeting or to join an established session or meeting.

An exemplary embodiment of the disclosed system and method is the Study Buddy Mobile Application that is compatible with devices such as iPhones, Androids, Tablets, and other devices that have Internet. This Study Buddy embodiment is also compatible with desktops and laptops. The application is designed using responsive design, shrinking the page halfway displays the mobile options only.

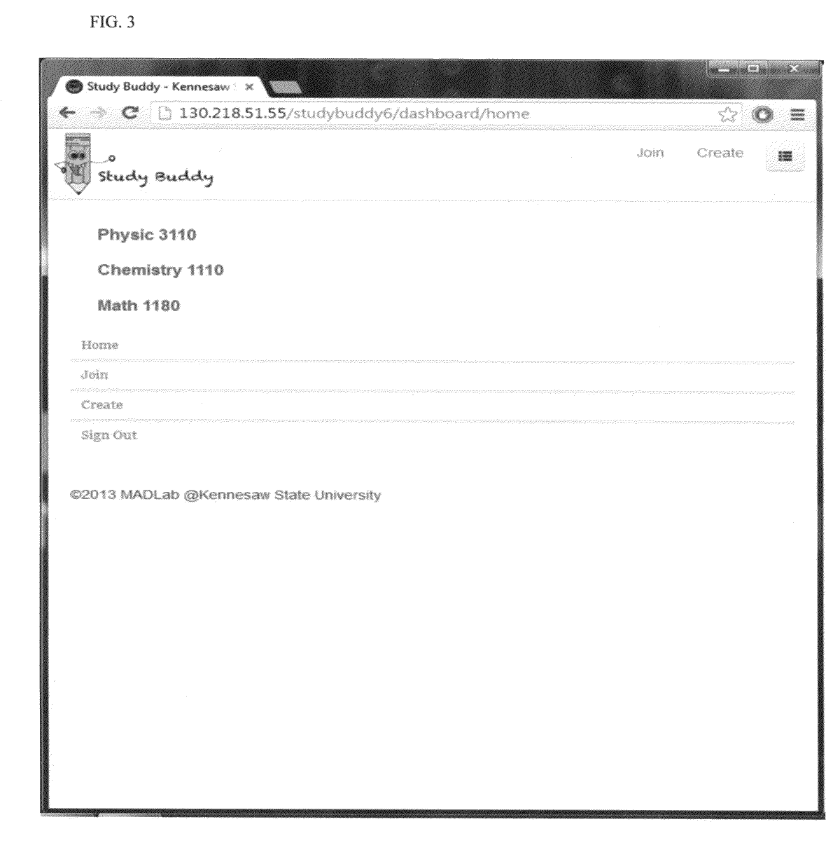

FIG. 3 shows a sample mobile application home page. In one embodiment, the home page displays the courses in which the student is enrolled. Other items that may be displayed include course titles, an option to join, an option to create, and a drop down menu. A click on one of the courses opens the sessions that are available to join. A click on a session expands to show the session information such as date, time, location, etc. The student can then join the session, or view ratings of the session creator. If no sessions are already made that the student wants to join, there is the option to create a new session for that course.

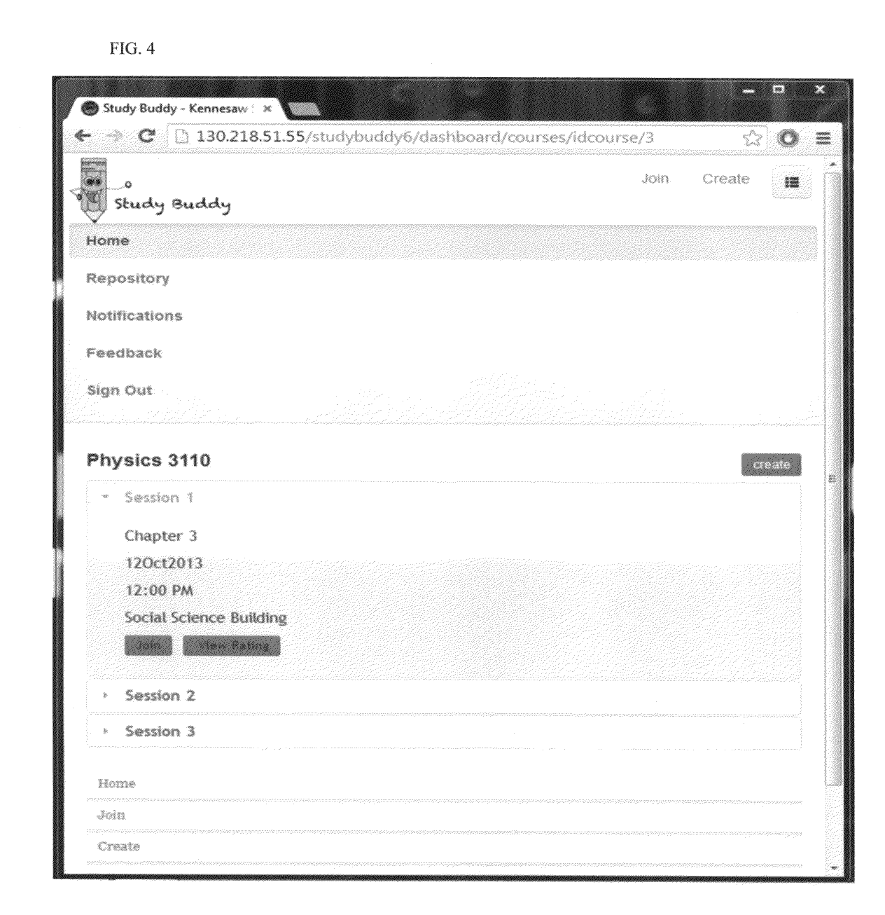

FIG. 4 shows a drop down home page menu item is placed on the top right. It displays the navigation options, e.g., home, repository, notifications, feedback, sign out, etc. The join option shows the sessions already created and provides the options of join, view rating, member count, pending request, and directions. Directions links directly to a campus map.

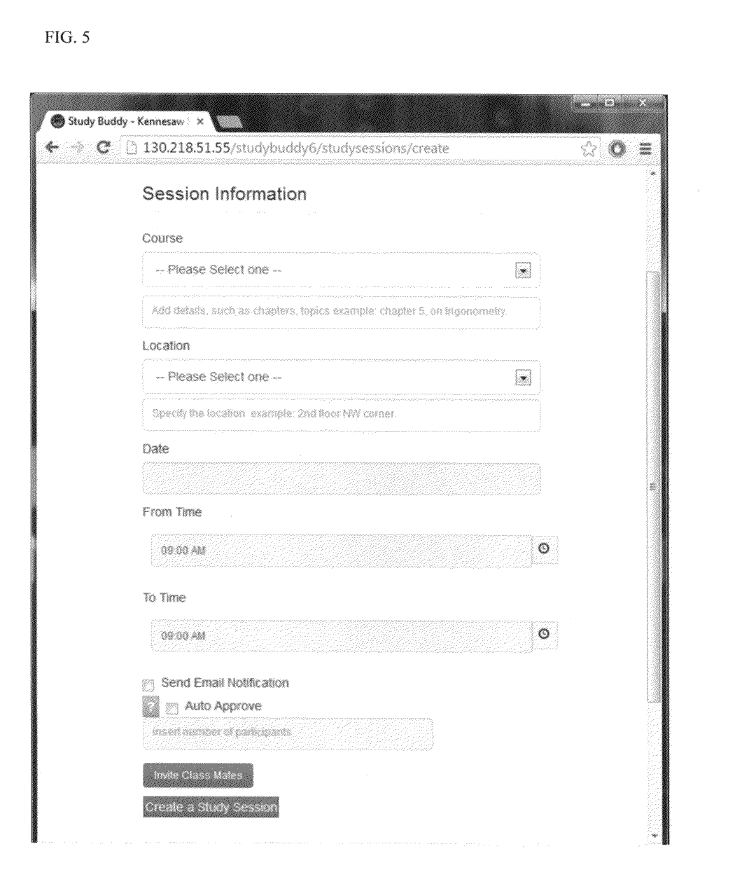

FIG. 5 shows a create option next to the join option. When the student clicks “create”, the sessions information page is accessed, which has a drop down menu for the following options: courses, location, date, duration (from time, to time), send email notification, auto approve, invite classmates, and create a study session.

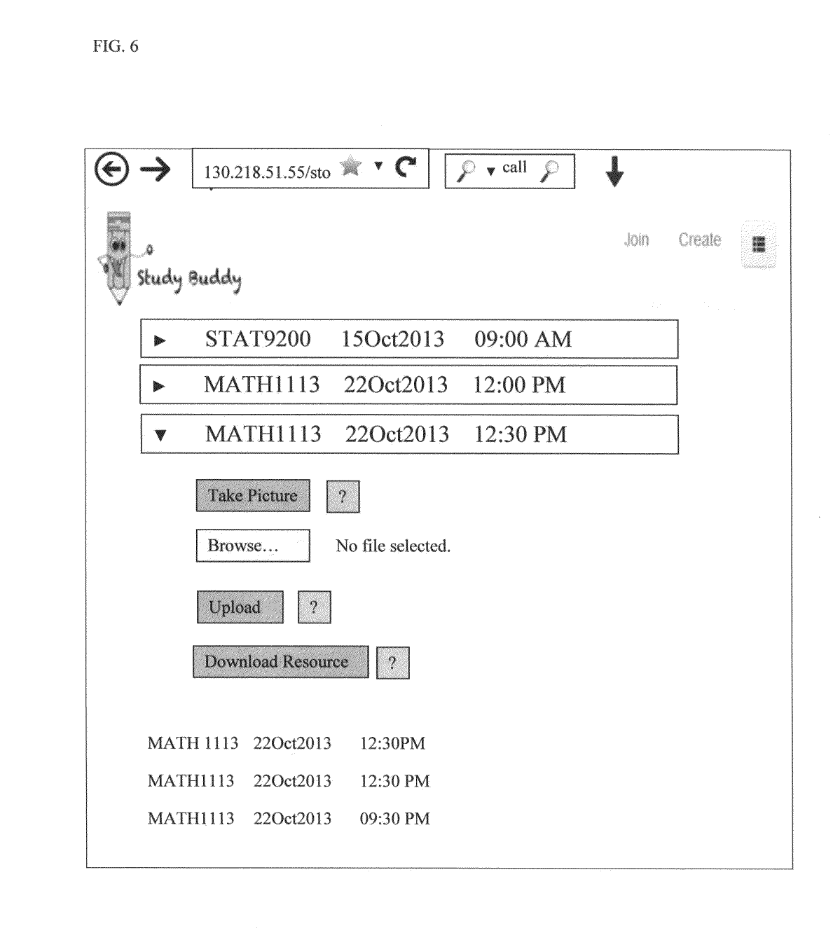

FIG. 6 shows a sample repository of the sessions the student attended. The repository provides the following options: take a picture of the work performed in the session, upload the picture, download the picture option. When the Take Picture button is clicked, the device camera is activated and allows a picture to be taken, previewed, and saved. Saved pictures can be retrieved using the Download Resource button allowing students to review work that occurred during the session.

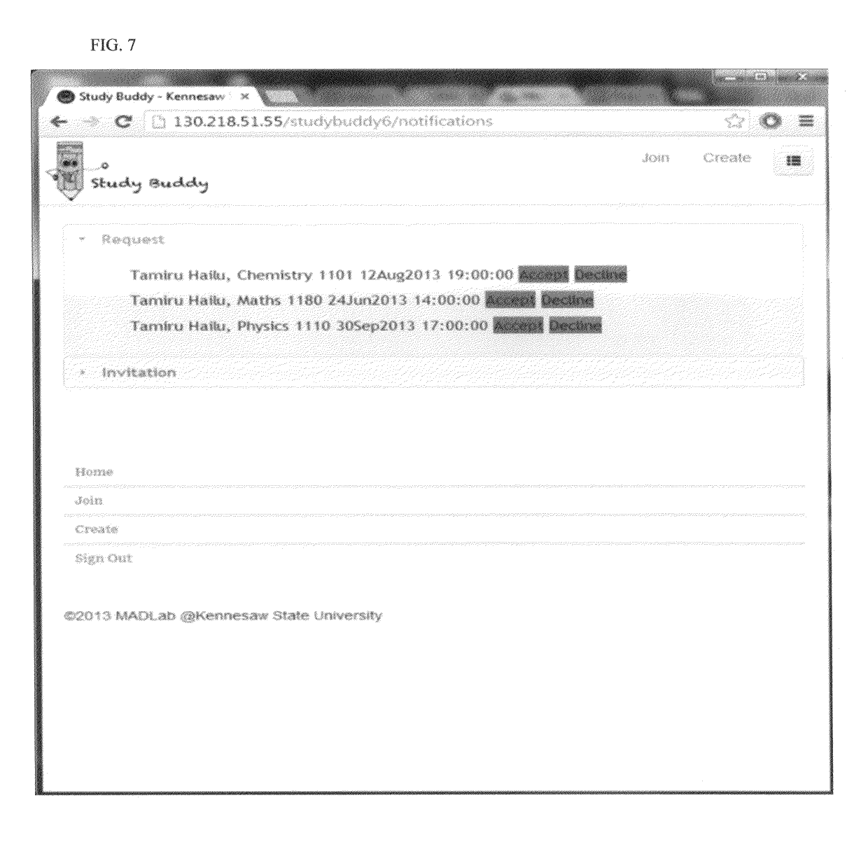

FIG. 7 shows the notifications option. Notifications allows access to My Session, Requests, and Invitations. Each of the Requests and Invitation drop down menus show the student name, course, date, time, and accept or decline. The Invitations menu shows the sessions to which the student has been invited.

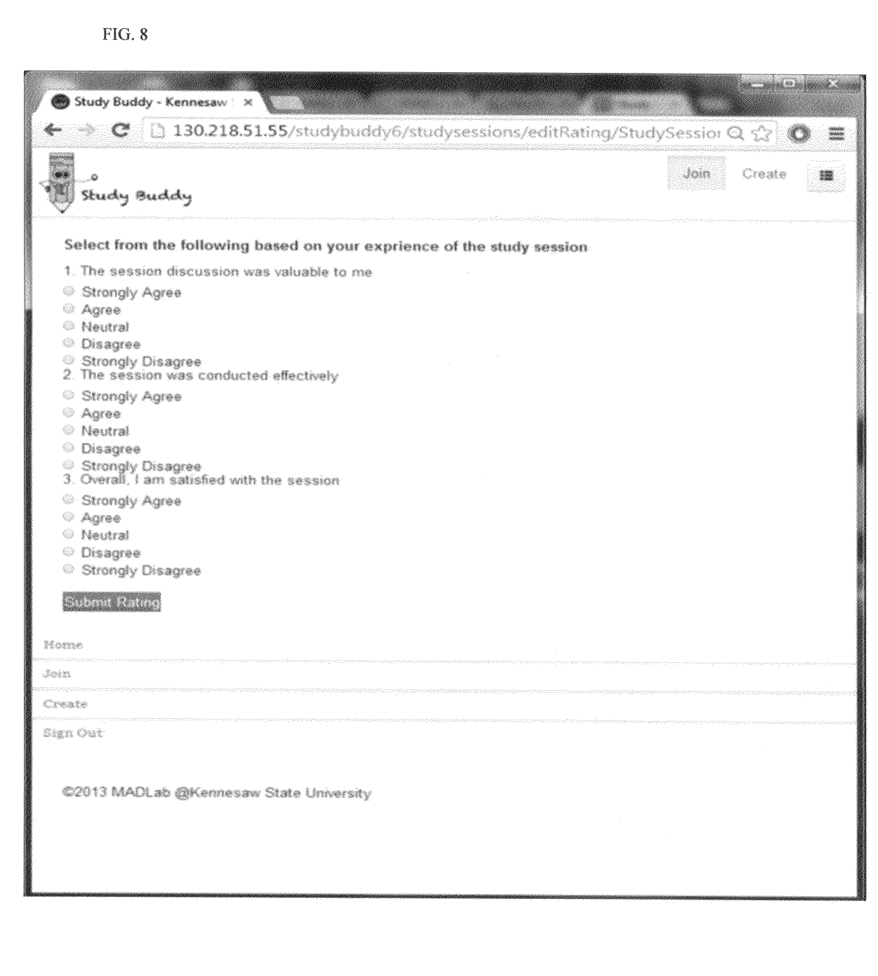

FIG. 8 shows the feedback menu. When the feedback option is clicked, all sessions that the student attended appear. When the student selects a session, the session date, time, and rate option appears. When the student clicks rate, three questions appear to determine the overall success of the session.

The disclosed system and method creates a networking platform for students to arrange virtual or physical meeting times and venues, avails scheduled study sessions, provides a secured log-in interface, authenticates only members that have registered for a specific course, allows students to link with their classmates, provides an access location feature on a portable electronic device to identify proximate location sessions, archives session outcomes and results thus creating a searchable knowledge repository, and provides feedback or reinforcement between faculty and students or among students. The disclosed system and method enables students to meet and study with one another outside of the classroom, which may result in improved student retention and graduation rates for a college or university.

In one embodiment, the user selects between approaches to receive a notification: pull notification or push notification. In pull notification, the student initiates access and is “pulled” into an existing scheduled session, e.g., the student selects an icon shown on a homepage display using a smartphone and joins a scheduled session. In push notification, the student initiates access by “pushing” his or her desired types of sessions (desired topic, desired location, desired length, desired session makeup, etc.) of which he or she desired notification; the system automatically notifies the student when some or all of the desired session criteria are met. The system also permits alteration between pull and push notifications. Either may be the default setting, but “pull” default is more common.

In one embodiment and as an additional security measure, the student uses his or her university assigned network name (e.g., a NetID) to access the system. Alternatively, the student creates a pseudo name. In one embodiment, a student may opt-out from using the pseudo name, however, the university assigned network name is then used instead. Students that set pseudo names may be identified using their pseudo name in the system instead of their university assigned network name.

A student may create a new session using multiple interfaces. In each case, a new session webpage opens when the student selects a “create a new session” button displayed on the electronic device screen. Inputs to the “create new session” page may be the name of a course and number, a building name and number, and notification format, i.e., pull or push. A session created with pull notification may be shown only in the location map of a home page for users to access. A session created with push notification may be automatically sent as a notification to users that set their profile for push notification, in addition to being displayed in the location map of the home page.

A session creator may include descriptive information about the course section being scheduled, e.g., chapter five of MATH1190 on trigonometry, and location e.g., northwest corner of the second floor at the main library). The session creator may invite participants using any number of approaches such as, e.g., ad/decline, select-a-member, or auto. In one embodiment, add/decline is the default setup. If the add/decline setup is selected, once the session is created other students may request to join the session. The requests to join the session are received by the session creator. The session creator may accept or decline the request. The session creator may terminate invitations once a preset number or pre-established demographic of participants have accepted. Other selection criteria are at the user's discretion and the range is apparent to one skilled in the art.

The select-a-member feature may be activated, e.g., displayed as a button on a webpage, where the session creator may select the button while creating the session. When selected, a page is opened listing a number of potential members. The session creator may then select the members that s/he desires as part of the session. The auto feature may be selected by the session creator at the time of session creation. The session creator may then specify a maximum number of participants allowed for the session. If the auto feature is enabled, the system will accept members on a first-come-first-serve basis, and automatically close the session once the maximum number of members is reached.

In one embodiment, sessions may be searched based on a course name (e.g., trigonometry), number (e.g., MATH1190), or location. In one embodiment, the session members may be asked to rate the session for coordination, value, and overall satisfaction. The ratings may be on a five point Liked scale, ranging from strongly agree to strongly disagree. Session ratings may be stored with a session creator profile, and students may view prior session ratings in advance of joining a new session.

The system may include a login/logout system integrated with the university's central authentication service. For example, at a student's first visit to the system home page, the student may be redirected to the university's central authentication service login page. At this site the student provide their university assigned network name (e.g., a NetID) and associated password to obtain authentication. Successful authentication redirects the user back to the application associated with the system. In one embodiment, first-time users may be directed to a registration interface, and users already registered are redirected to the application home page. Integration with the university's central authentication service enables a single sign on system where users may not have to re-enter their university assigned network name and password each time they access different system services.

The system may also include features, e.g., registration, profile updates, a dashboard home with map display, the ability to request a session, the ability to invite users to a session, etc., subsequently disclosed in more detail. For example, system access may require advanced registration. First-time users may be authenticated on the university's central authentication service. Once authenticated, first-time users are directed to a registration page associated with the system and may be asked to enter their name, university issued ID number, network name, email address, pseudo name, and choice how to receive notifications, e.g., pull or push. The registration login information may be sent to a university's security and authentication interface for validation. The authentication interface is configured to authenticate valid university registered students and return the authenticated network name to the system. Non-authenticated users may be asked to contact university administration.

Authenticated members of the system may change information entered during registration through a profile page. Parameters that may be changed include, e.g., email address, email use, notification e.g., push or pull, pseudo name, etc. An email address entered during registration may be used to notify students about sessions and activities associated with the system.

In one embodiment, the system home page displays a university location map. Unexpired study sessions are noted with a bubble, e.g., a red bubble may indicates sessions starting within 24 hours, a blue bubble indicates session starting beyond 24 hours. The bubbles are displayed at location coordinates of a selected meeting location. If multiple sessions are scheduled at the same location, e.g., an orange bubble with an aggregated number of session counts inside the bubble may be displayed on the location map. In one embodiment, the map may also display a live study session currently occurring in real-time. It may include a countdown timer to inform the user of the amount of session time remaining.

If a portable electronic device, e.g., a smartphone, is used to execute the application, the portable electronic device may include an access location feature indicating a geographical location of the portable electronic device. The system may then identify location sessions associated with the specific course that are within a predetermined distance from the geographical location of the portable electronic device.

The system may also include a sessions webpage that displays a summary of sessions associated with a specific user that has logged into the system. For example, the sessions webpage may display sessions created, sessions joined, sessions of which the logged-in user is a member, sessions requested, etc. The sessions page may also display a button that may be selected to create a new session. The system may further include a requests page that displays requests to join the session created by the specific user. The session creator may add or decline a request to join the session. Added members will see the session in the session page, and declined members will see their request without acceptance. The system may also include an invites page that shows any invitations the logged-in user has received. When a session creator identifies specific members desired for a specific session, the invites page of the selected members displays the invitation. In one embodiment, the system may also include a members page display that lists the members associated with the session. The member's pseudo name may be displayed if applicable, otherwise a university assigned network name associated with the member is displayed. The members page display may list of relevant information about the member, e.g., their major field of study, etc.

In one embodiment, the system may generate an approved list of classes that are displayed on a class page. The highest level of abstraction is by departmental course name abbreviation, e.g., BIOL for any biology course, CHEM for any chemistry course, MATH for any mathematics course, PHYS for any physics course, etc. The levels can be expanded or collapsed. The next level of abstraction is by course level e.g., 1000 for an introductory course, 2000 for a course with an introductory course as a prerequisite, 3000 for an advanced course, 4000 for an advanced course and/or for a course with a research component, etc. These levels can be expanded or collapsed. Course level numbers, e.g., MATH 1190, will display when the 1000 level in the MATH section is expanded. In one embodiment, each course designation has a button displayed that allows a user to create a new session. In one embodiment, each course designation has a button displayed that allows a user to join the session if a session has already been created.

The system may also include other features that may be combined. In one embodiment, the system includes the ability to upload work, e.g., assignments, projects, readings, tutorials, etc. The work may be uploaded by session members only, or by all students enrolled in the class, or by selected groups of students such as students with a major in the field of study. The system may include the ability to view work, e.g., an access profile for faculty and/or other authorized facilitators such as teaching assistants, etc., may be provided to view student submissions. In one embodiment, the application is primarily a student system, and non-student access is permitted only with student consent and without substantially compromising a student-driven system.

The system may include a user guide with documentation, e.g., web services, online user manuals and guides, troubleshooting information, etc. In one embodiment, the system includes a student portal that sorts sessions based on student registration. In one embodiment, the system includes instructor privileges, e.g., an instructor login. In one embodiment, the system includes session logs that track student participation, e.g., hours or minutes in each session, work performed in each session, post-session notes or comments prepared, etc. In one embodiment, the system integrates classroom tools and applications for extended learning.

In one embodiment, the system includes means for virtual participation, e.g., for students who are not able to participate in physical meetings. However, in a university with a substantial commuter student population, particularly with a substantial undergraduate population, the value of in-person face-to-face meetings is noted. The disclosed system and method, while operable in a virtual environment, encourages and facilitates at least some physical meetings. For example, the disclosed system and method uses the GPS capability of smart phones to locate proximate study groups and facilitates session organization based on topic, location, time, etc.

In one embodiment, the system includes the ability to grade student submissions. In one embodiment, the system includes simulations, practice problems, alternate problem solving approaches, etc. In one embodiment, the system uses social networking tools to facilitate networking, collaboration, communication, etc. In one embodiment, the system includes self-feedback on performance generated based mastery, confidence, dialog, etc. of student performance. In one embodiment, the system includes uploads to video clips, links, posts, etc.

The system facilitates student association with a common goal and fosters camaraderie. Students who desire to study one or more courses together may be referred to as “study buddies”. For example, a student may post a request to study a particular course at specific location and time using the system. This creates a study session. Members may choose a favorite student or “study buddy” representing a study session considered as valuable by its participants and persisted as a study buddy, and set a location and recurring schedule. In this case, a system alert would be created and member students are notified based on the recurring schedule. A “study buddy” may be associated with more than one subject and/or course. In one embodiment, students may comment and rate the participation of another student who is part of a study session.

In one embodiment, the system includes technical architecture components. The architecture components include a back-end that represents the behind-the-scenes operation of the system. The architecture components include a mobile application that represents a front-end or user interface of the system. The architecture components include an administrative client that represents administrative functions of the system. The back-end maintains student profiles, allows creation of study sessions, facilitates session or other requests, approves membership to a system, promotes a session to a student or “study buddy” association, broadcasts alerts to members of a student association if a study session is created, etc. The mobile application searches and identifies study sessions by subject, members, location, and/or keywords. The mobile application may also request membership to a study session, show the map-based location of a study session, create a study session, propose a change to a study session, propose and implement a breakdown of a study session, create and/or join a student or “study buddy” from a study session, manage membership to a “study buddy” and merge two or more “study buddies” into a single entity, etc.

The disclosed system and method combines and extends a traditional an in-person study session among two or more students with social networking tools. Extension is by sustaining and socializing it using mobile, desktop, and social networking tools. It thus extends in-class discussions and encourages and facilitates their application into a social, collaborative event, where colleagues but not necessarily friends who share a common classroom experiences self-select and self-aggregate to achieve a common goal of course mastery. Peer and in some cases instructor feedback may be provided further enhancing the educational experience. Venue may be a dining hall, coffee bar, residence hall, library, lobby, etc.; all become extensions of the classroom. Particularly in a largely commuter university, where many students see their classmates for the brief class session and rush to the next appointment, class, or work, now become a “buddy” network with similar goals: a learner with improved retention, progression, and graduation rates.

The authentication process interfaces with existing closed networks. The open login system accepts all login requests and delimits, based on the receiving closed network, between authenticated and declined users with appropriate and timely responses to each. As one skilled in the art will appreciate, the disclosed system and method may still occur but without a physical meeting. In one embodiment, all other components except the physical meeting occur, so that the disclosed system and method operates virtually. In one embodiment, selected portions of the disclosed system and method occur to result in discrete sections of the inventive system and method. As examples only, the assignment collaboration tool, classmate networking tool, authenticating members for joint work may occur as separate units.

The following example is illustrative and not limiting. Students at a primarily commuter university were enrolled in three separate six-week summer sessions of calculus and pre-calculus. The overall student use was robust and student response was favorable.

The embodiments shown and described in the specification are only specific embodiments of inventors who are skilled in the art and are not limiting in any way. Therefore, various changes, modifications, or alterations to those embodiments may be made without departing from the spirit of the invention in the scope of the following claims. The references cited are expressly incorporated by reference herein in their entirety.

What is claimed is:

1. A computer-implemented method connecting users to one another based on a common educational focus, comprising the steps of
establishing communication between an electronic device and a web server;
authenticating a first user identifier representing a first student associated with the common educational focus,
creating a set of access rights associated with the first user identifier,
allowing access of at least a second user to a session based on the access rights, where the session is associated with the common educational focus.

2. A system for connecting users to one another based on a specific educational focus, the system comprising
a web server that provides information about a course associated with the educational focus,
a software application hosted on an electronic device in communication with the web server capable of authenticating a user identifier representing a user, where the authenticating is based on the user's affiliation with the educational focus, and
a database server that stores a plurality of user identifiers associated with the educational focus.

3. The method of claim 1 where the electronic device is a portable electronic device or a personal computing device.

4. The method of claim 1 comprising establishing communication between the web server and a database server, where the database server stores a plurality of user identifiers associated with the common educational focus.

5. The method of claim 1 where the common educational focus is a classroom course.

6. The method of claim 1 where the user identifier is a university assigned network name or a pseudo name.

7. The method of claim 1 comprising displaying a campus map.

8. The method of claim 1 further comprising the step of sending an invitation to join the session to a user identifier account associated with the common educational focus.

9. A system for connecting users to one another based on a common educational focus associated with a classroom-based course, the system comprising:
a web server; and
an electronic device in communication with the web server, the electronic device configured to perform the method comprising
authenticating a first user identified representing a first student associated with the common educational focus,
creating a set of access rights associated with the first user identifier,
allowing access to a session based on the plurality of access rights,
where the session is associated with the common educational focus, and
where a second user identifier has also been allowed access to the session.

10. The system of claim 9 where the electronic device is a portable electronic device or a personal computing device.

11. The system of claim 10 where the portable electronic device includes an access location feature indicating a geographical location of the portable electronic device.

12. The system of claim 10 where the portable electronic device includes control logic for identifying location sessions associated with the specific course.

13. The system of claim 10 where the portable electronic device includes control logic for downloading and installing an application from the web server, and where the application authenticates the user identifier and allows the user to establish or join the session.

14. The system of claim 9 where the web server establishes communication with a database server, where the database server stores a plurality of user identifiers associated with the common educational focus.

15. The system of claim 9 where the user identifier is a university assigned network name or a pseudo name.

16. The system of claim 9 where the electronic device includes a display.

17. The system of claim 9 where the electronic device includes control logic for sending an invitation to join the session to another user identifier associated with the common educational focus.

18. The method of claim 1 where the authenticating step comprises
sending a request for authentication of the first user identifier from the electronic device to the web server, and
verifying a right to access the session for the first user identifier.

19. The method of claim 1 where the creating step comprises
associating the set of access rights with the first user identifier and the common educational focus, and
storing the associated set of access rights on a database server.

20. The method of claim 1 where the allowing step comprises
receiving a request for access to the session,
confirming that the set of access rights have been associated with the first user identifier and the common educational focus, and
permitting access by the first user identifier into the session.
